(19) United States
(12) Patent Application Publication
(10) Pub. No.: US 2026/0355665 A1
(43) Pub. Date: Nov. 12, 2026

(54) Demister with Improved Liquid Drainage

(71) Applicant: CHEVRON U.S.A. INC., San Ramon, CA (US)

(72) Inventors: Christine Marie Long, El Cerrito, CA (US); Victor van Asperen, Tomball, TX (US)

(21) Appl. No.: 19/664,216

(22) Filed: Apr. 30, 2026

Related U.S. Application Data
(60) Provisional application No. 63/802,792, filed on May 9, 2025.

(51) Int. Cl. B01D 46/00

(52) U.S. Cl. CPC B01D 46/0031

(57) ABSTRACT

A demister, such as a mesh demister or a vane pack demister, is used in a separator vessel to separate liquid droplets from a vapor stream. A mesh demister includes a lower grid that supports the mesh demister and forms a mesh peak. The mesh peak facilitates draining of collected liquid from the mesh into a drain channel. By facilitating draining of collected liquid from the mesh, excessive liquid does not accumulate in the mesh where it would interfere with the performance of the mesh.

### CROSS-REFERENCE TO RELATED APPLICATION

This application claims priority to and the benefit of U.S. Provisional Patent Application No. 63/802,792 titled “Demister With Improved Liquid Drainage” and filed on May 9, 2025, the entire contents of which are incorporated herein by reference.

### TECHNICAL FIELD

Embodiments of the technology relate generally to a demister, such as a mesh demister or a vane pack demister, that facilitates drainage of accumulated liquid from the demister.

### BACKGROUND

A demister, such as a mesh demister or a vane pack demister, can be placed in a vapor stream to remove liquid droplets from the vapor. Demisters are commonly used in petrochemical processing plants as well as other industrial processes. In the case of a mesh demister, a mesh material commonly made of metallic or polymer fibers is supported by a frame or grid structure. As a vapor stream passes through the mesh demister, liquid droplets attach to the mesh and are removed from the vapor stream. In certain mesh demisters, the liquid droplets drain from the mesh by simply falling from the bottom of the mesh. However, for mesh demisters that operate at higher liquid loads, sometimes referred to as flooded mesh demisters, the liquid droplets coalesce gradually on the mesh material and are drained from the mesh material by a drain channel.

A mesh demister is typically mounted within a vessel with the major axis of the mesh demister in a horizontal position so that a vapor stream traveling upward within a vessel passes through the mesh demister. As such, the mesh material of the mesh demister is typically in a generally horizontal position and typically fills the entire vessel horizontal cross-sectional area when in use so that vapor cannot bypass the demister mesh. The horizontal position of the mesh material can inhibit draining of liquid from the mesh demister because the liquid must flow downward against the upward flow of the vapor stream. Accordingly, a mesh demister with improved drainage characteristics would be beneficial.

A flooded vane pack demister functions similarly to a flooded mesh demister, but instead of a mesh material, the demister relies upon a series of closely spaced parallel sheets of corrugated sheet metal, called vanes, to separate liquid droplets from a vapor stream. Accordingly, the embodiments described below are equally applicable to a flooded vane pack demister.

### SUMMARY

In one example embodiment, the present disclosure is generally directed to a mesh demister that includes a non-horizontal mesh pad to facilitate drainage of liquid from the mesh pad. More specifically, the mesh demister can comprise: (a) a height and a perimeter, wherein the perimeter at a top of the mesh demister defines a horizontal top plane; (b) a first drainage channel extending across a portion of the mesh demister, the first drainage channel comprising a first flange support extending from a bottom surface of the first drainage channel; (c) a mesh pad disposed adjacent the first drainage channel, the mesh pad comprising a top surface, a bottom surface, a first longitudinal side, and a second longitudinal side, wherein the first longitudinal side is supported by the first flange support, and wherein the top surface is non-horizontal when the mesh demister is in use; (d) a first lateral support and a second lateral support, the first and second lateral supports supporting the first drainage channel; and (e) a lower grid comprising a lower grid lateral segment and a lower grid longitudinal segment, the lower grid longitudinal segment extending from the first lateral support to the second lateral support, wherein the lower grid longitudinal segment supports a mesh peak of the mesh pad.

In a second example embodiment, the present disclosure is generally directed to a vane pack demister that includes a non-horizontal vane pack to facilitate drainage of liquid from the vane pack. More specifically, the vane pack demister can comprise: (a) a height and a perimeter, wherein the perimeter at a top of the vane pack demister defines a horizontal top plane; (b) a first drainage channel extending across a portion of the vane pack demister, the first drainage channel comprising a first flange support extending from a bottom surface of the first drainage channel; (c) a vane pack disposed adjacent the first drainage channel, the vane pack comprising parallel sheets of corrugated metal forming a vane top plane, a vane bottom plane, a first longitudinal side, and a second longitudinal side, wherein the first longitudinal side is supported by the first flange support, and wherein the vane top plane is non-horizontal when the vane pack demister is in use; (d) a first lateral support and a second lateral support, the first and second lateral supports supporting the first drainage channel; and (e) a lower grid comprising a lower grid lateral segment and a lower grid longitudinal segment, the lower grid longitudinal segment extending from the first lateral support to the second lateral support, wherein the lower grid longitudinal segment supports a vane pack peak of the vane pack.

The foregoing embodiments are non-limiting examples and other aspects and embodiments will be described herein. The foregoing summary is provided to introduce various concepts in a simplified form that are further described below in the detailed description. This summary is not intended to identify required or essential features of the claimed subject matter nor is the summary intended to limit the scope of the claimed subject matter.

### BRIEF DESCRIPTION OF THE DRAWINGS

The accompanying drawings illustrate only example embodiments of a mesh demister and therefore are not to be considered limiting of the scope of this disclosure. The principles illustrated in the example embodiments of the drawings can be applied to alternate methods and apparatus. Additionally, the elements and features shown in the drawings are not necessarily to scale, emphasis instead being placed upon clearly illustrating the principles of the example embodiments. Certain dimensions or positions may be exaggerated to help visually convey such principles. In the drawings, the same reference numerals used in different embodiments designate like or corresponding, but not necessarily identical, elements.

FIG. 1 illustrates a mesh demister placed within a vertically-oriented vessel in accordance with an example embodiment of the disclosure.

FIG. 2 illustrates a cross-sectional view of a mesh demister in accordance with an example embodiment of the disclosure.

FIG. 3 illustrates a top perspective view of a mesh demister in accordance with an example embodiment of the disclosure.

FIG. 4 illustrates a bottom perspective view of a mesh demister in accordance with an example embodiment of the disclosure.

### DETAILED DESCRIPTION OF EXAMPLE EMBODIMENTS

The example embodiments discussed herein are directed to demisters. The example apparatus and methods described herein are particularly beneficial in the oil and gas industry where it is typical to separate liquid droplets from a vapor stream in order that the liquid droplets do not interfere with downstream processes or equipment or contaminate gas products. The examples described herein improve upon prior approaches in that they facilitate drainage from the demister of the liquid that forms from the coalesced liquid droplets that collect on the demister. Improving the drainage of liquid from the demister enables the demister to collect more liquid droplets from vapor passing through the demister and, therefore, improves the performance of the demister and improves the efficiency of the demister, reducing liquid entrainment in the effluent vapor stream.

In the following paragraphs, particular embodiments will be described in further detail by way of example with reference to the drawings. In the description, well-known components, methods, and/or processing techniques are omitted or only briefly described. Furthermore, reference to various feature(s) of the embodiments is not to suggest that all embodiments must include the referenced feature(s). While the embodiments illustrated in the figures and described below are primarily directed to a mesh demister, the teachings herein also are applicable to a vane pack demister.

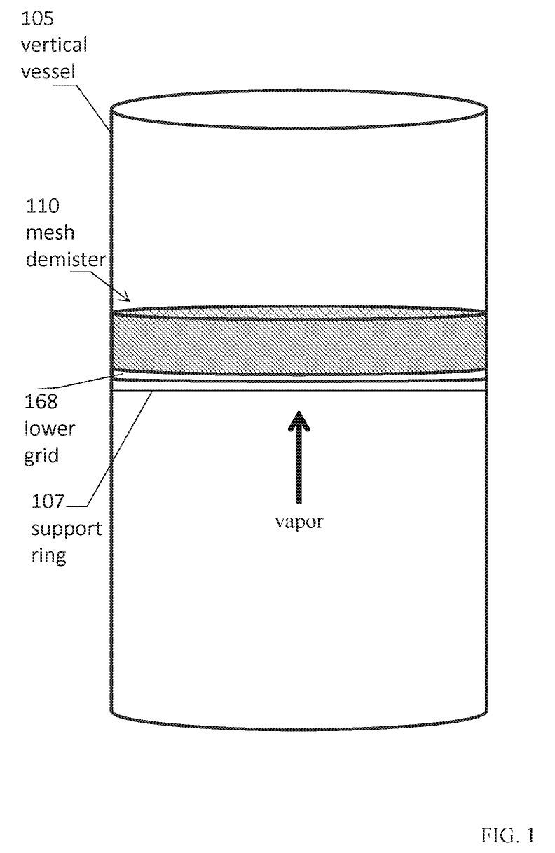

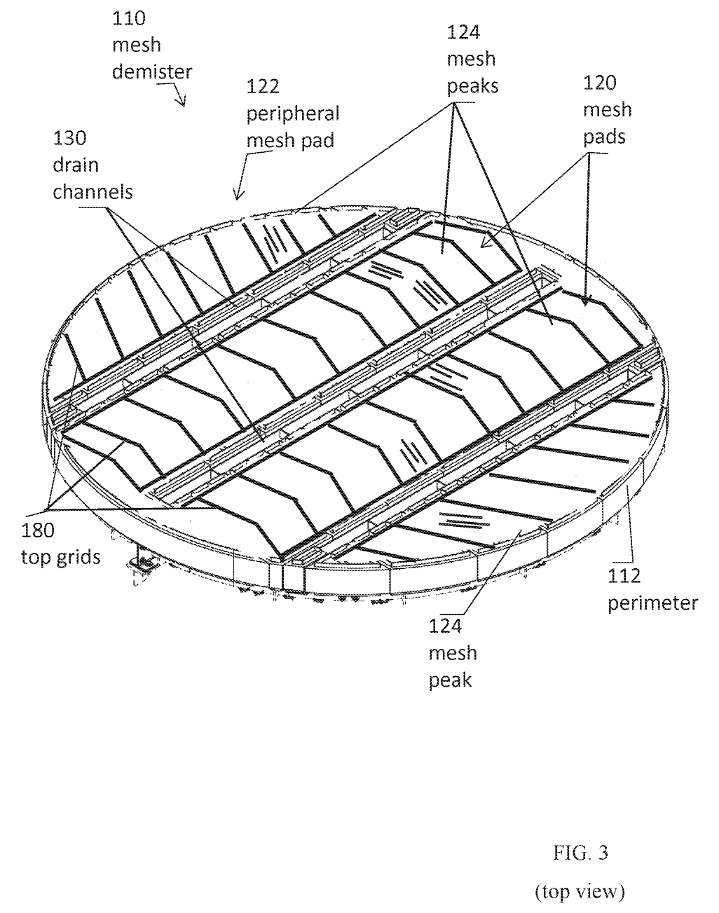

FIG. 1 illustrates a mesh demister 110 placed in a vertically oriented vessel 105. The vertically oriented vessel 105 may be a variety of vessels used for separation, such as a fractionation column or a distillation column or a 2-phase or 3-phase separator vessel. As illustrated in FIG. 1, the mesh demister 110 has a generally cylindrical shape, though it may be fabricated in smaller segments. The complete mesh demister has a height 113 and a perimeter 112. Mesh demisters commonly have a thickness of between four and twelve inches, however, the features of the mesh demister shown in FIGS. 1-4 are for illustrative intent and not all features are drawn to scale. A support ring 107 is attached to the inner circumference of the vessel 105 and supports a lower grid 168, which in turn supports the mesh demister 110. In alternate embodiments, instead of the support ring 107 located below the demister, the demister may be supported from above wherein it attaches to or hangs from a support ring or housing located above the demister within the vessel. The mesh demister typically includes a top grid as well, which is omitted from FIG. 1 but is shown and described in connection with FIG. 3 below.

The mesh demister 110 is oriented in the vessel 105 so that the mesh demister’s major top and bottom surfaces are generally horizontal. In other words, the mesh demister’s major top and bottom surfaces define planes that are generally perpendicular to the direction of flow of the vapor stream that is traveling upward through the vessel 105. The mesh demister 110 fills the horizontal cross-sectional area of the vessel 105 and fits tightly against the interior walls of the vessel 105 so that the vapor traveling upward must pass through the mesh demister 110. As the vapor travels upward and passes through the mesh demister 110, liquid droplets from the vapor attach to the mesh and, thus, are removed from the vapor. In a flooded demister, the vapor pushes the liquid droplets to the top of the mesh, where they coalesce into a liquid that must flow horizontally into the drainage channels. By orienting the mesh in a non-horizontal position, a slope is formed that facilitates drainage of the liquid into the channels.

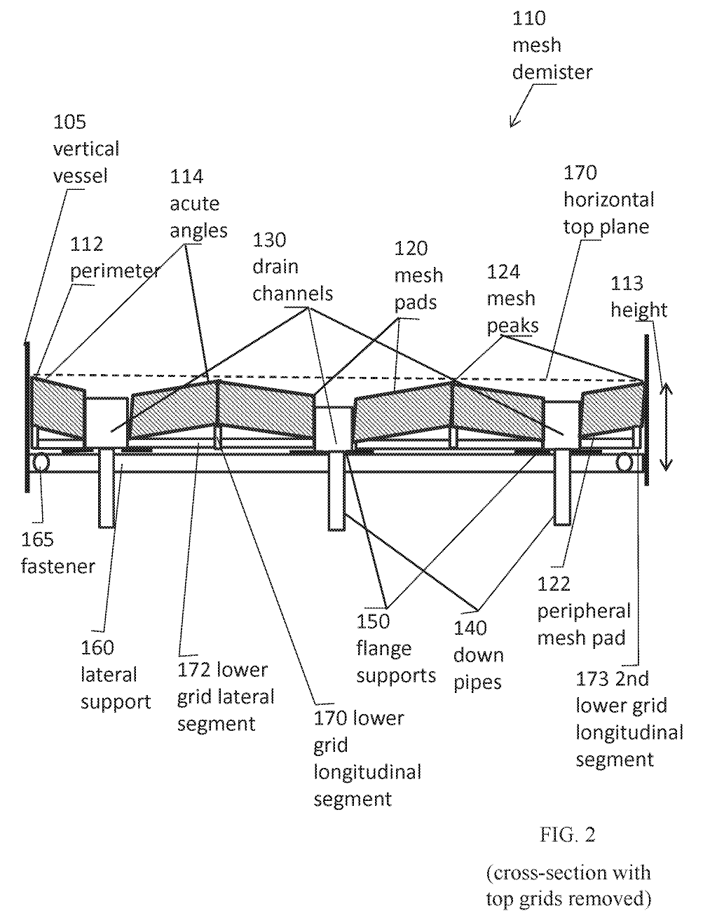

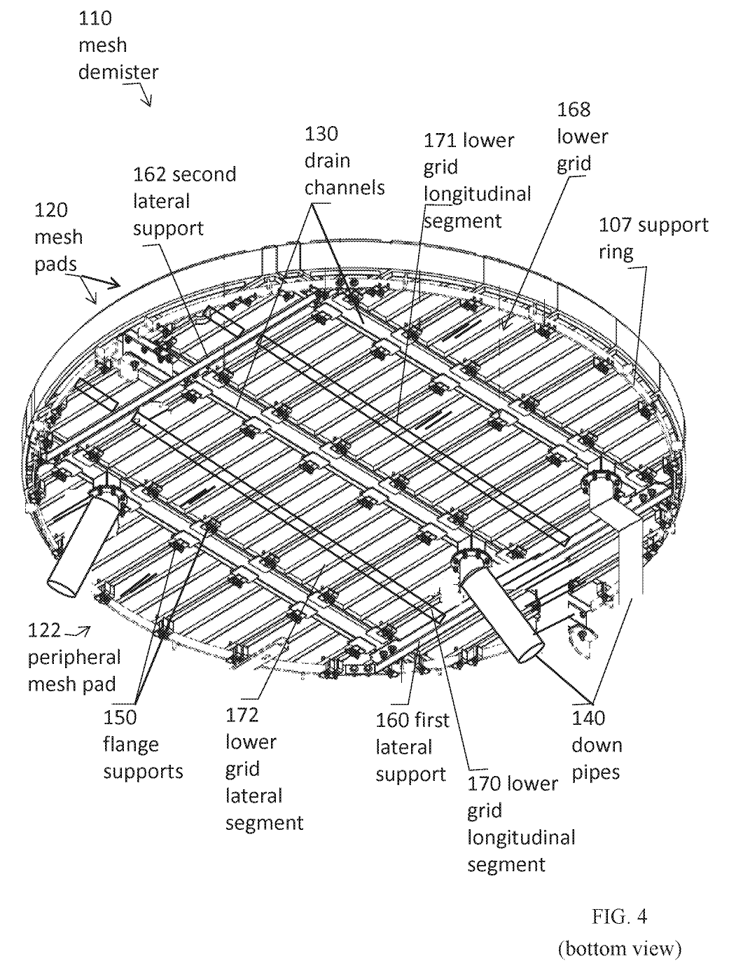

Referring now to FIGS. 2, 3, and 4, the mesh demister 110 is shown from different perspectives. FIG. 2 illustrates a cross-sectional view of the mesh demister 110 when it is positioned within the vessel 105. FIG. 3 illustrates a top perspective view of the mesh demister 110 without the vessel 105 being shown. FIG. 4 illustrates a bottom perspective view of the mesh demister 110 without the vessel 105 being shown. While specific components of the mesh demister 110 will now be described, these descriptions are illustrative examples and are not limiting of the improvements described herein. The improvements described herein also can be applied to demisters having other components or configurations.

As illustrated in FIG. 2, the mesh demister 110 has a height 113 and a top edge of the perimeter 112 defines a horizontal top plane 170, which can serve as a reference when describing the position and orientation of the other components of the mesh demister 110. The example mesh demister 110 includes four mesh pads, but in alternate embodiments a different number or arrangement of mesh pads may be used. The mesh pads typically are fabricated in sections to facilitate installation and to allow the mesh pads to fit through narrow spaces such as a manway opening in the vessel. In the case of a vane pack demister, the mesh pads would be replaced with a vane pack.

In the example of FIG. 2, two of the mesh pads, which are mesh pads 120, are located in the central portion of the demister and are positioned along a diameter of the demister. At the periphery of the demister are two peripheral mesh pads, the peripheral mesh pads 122. Each of the mesh pads can have a top surface, that faces toward the horizontal top plane 170 at the top edge of the mesh demister along the perimeter 112, and a bottom surface that is opposite the top surface. Each of the example mesh pads of mesh demister 110 also has two long edges, which are referred to as the first and second longitudinal sides. The mesh pads 120 located along the center of the mesh demister 110 also have opposing short edges, which are referred to as the first and second lateral sides. The peripheral mesh pads 122 do not have lateral edges in the example of FIGS. 2-4 because in each of the peripheral mesh pads 122 one of the longitudinal sides curves to meet the other longitudinal side.

As illustrated in FIGS. 2-4, the top surfaces of the mesh pads 120 and the peripheral mesh pads 122 are non-horizontal. In other words, the top surfaces of the mesh pads 120 and the peripheral mesh pads 122 form an acute angle 114 with the horizontal top plane 170. This acute angle formed by the top surfaces of the mesh pads 120 and the peripheral mesh pads 122 facilitates drainage of liquid from the mesh into drainage channels. In the example of mesh demister 110, there is a drainage channel 130 located between each adjacent pair of mesh pads for a total of three drainage channels 130. In alternate embodiments, there may be fewer drainage channels or more drainage channels than the three illustrated in the example of FIGS. 2-4. Each of the drainage channels 130 includes at least one down pipe 140 for removing liquid that has collected in the drainage channels 130. In alternate embodiments, a drainage channel may have more than one down pipe, particularly for large vessels or where a substantial amount of liquid must be drained from the demister. While the down pipes are illustrated as having a cylindrical shape in FIG. 4, the down pipes may have other configurations such as a rectangular cross-section.

The underside of the mesh demister 110 includes supporting structures that cause the mesh pads 120 and the peripheral mesh pads 122 to have the non-horizontal orientation described above. In the example of mesh demister 110, the mesh pads 120 and the peripheral mesh pads 122 have a uniform thickness between the respective top surfaces and bottom surfaces of the mesh pads and the peripheral mesh pads. Given the uniform thickness, the supporting structures are needed to achieve the non-horizontal orientation. In general, mesh pads having a uniform thickness are preferred because a non-uniform thickness tends to produce undesirable pressure differentials in the vapor that is flowing through the mesh demister. However, in alternate embodiments, the non-horizontal orientation of the mesh pads could be achieved with mesh pads that have a non-uniform thickness causing an acute angle in at least a portion of the mesh pad relative to the horizontal top plane 170.

As illustrated in FIGS. 2-4, there are multiple components on the underside of the mesh demister 110 that support the mesh pads and the peripheral mesh pads and provide the non-horizontal orientation of the mesh pads and the peripheral mesh pads. The supporting components on the underside of the mesh demister 110 that are illustrated in FIGS. 2-4 are only one example and in alternate embodiments different arrangements of supporting components may be used. In the example of FIGS. 2-4, the underside of the drainage channels 130 have flange supports 150 that extend horizontally from each side of the drainage channels 130. As illustrated in the bottom view of FIG. 4, each drainage channel can have multiple pairs of flange supports 150. The flange supports 150 support a lower grid 168 that is positioned below each mesh pad 120 and peripheral mesh pad 122. In the case of each mesh pad 120, the lower grid 168 comprises multiple lower grid lateral segments and at least one lower grid longitudinal segment. As illustrated in FIGS. 2 and 4, one mesh pad 120 is supported by multiple lower grid lateral segments 172 and by one lower grid longitudinal segment 171, 172. Similarly, the other mesh pad 120 is supported by multiple lower grid lateral segments and one lower grid longitudinal segment 171. The lower grid longitudinal segments 171, 172 form a mesh peak 124 in each of mesh pads 120. The mesh peak 124 provides the non-horizontal orientation of the mesh pad 120 by forming an acute angle between the top surface of the mesh pad and the horizontal top plane 170. Forming this acute angle inhibits liquid droplets from pooling and accumulating excessively on and/ or in the mesh and, instead, facilitates drainage of the liquid formed by coalesced droplets toward the drain channels. The magnitude of the acute angle can be controlled by the height of the lower grid longitudinal segment and can be selected based upon the specifics of the use case, including the surrounding equipment and the composition of the vapor and the liquid droplets. As an example, the acute angle may be in a range of from 2 degrees to 20 degrees.

The peripheral mesh pads 122 have a similar mesh peak 124 to facilitate drainage of liquid formed from coalesced droplets that attach to the peripheral mesh pads 122. In the example of mesh demister 110, the peripheral mesh pad 122 is supported by a lower grid 168 comprising a lower grid lateral segment. Additionally, the peripheral mesh pad is supported by a second lower grid longitudinal segment 173. The second lower grid longitudinal segment 173 provides the non-horizontal orientation that produces the mesh peak 124 of the peripheral mesh pad 122, which facilitates drainage of liquid from the peripheral mesh pad 122. In alternate embodiments, the peripheral mesh pad may be supported by other structures.

The example mesh demister 110 is further supported by a plurality of lateral supports. Specifically, as illustrated in FIGS. 2 and 4, a first lateral support 160 and a second lateral support 162 extend along a bottom of the mesh demister 110. The first lateral support 160 and the second lateral support 162 are fastened to the support ring 107 of the vessel 105 by fasteners 165 as illustrated in FIGS. 2 and 4. To secure the lateral supports 160 and 162 to the mesh demister 110, they may be fastened to the bottom surfaces of the drainage channels as further illustrated in FIG. 4.

As illustrated in FIG. 3, the mesh demister 110 may also include one or more top grids 180. The top grid typically is slightly smaller than the mesh pad on which it is placed and applies a compressive force on the mesh pad. In the example of FIG. 3, a top grid 180 is placed on each of the mesh pads 120 and the peripheral mesh pads 122. The top grids 180 on the mesh pads 120 are configured with a peak to accommodate the mesh peaks 124. Similarly, the top grids 180 on the peripheral mesh pads are configured to attach to the mesh demister at an acute angle relative to the horizontal top plane 170 to accommodate the mesh peaks 124 of the peripheral mesh pads 122.

As referenced above, a flooded vane pack demister is an alternate type of demister that functions similarly to a flooded mesh demister. The improvements described herein for a mesh demister can be similarly applied to a flooded vane pack demister wherein the vane pack is oriented in a non-horizontal position to create a slope that facilitates drainage of liquid into the channels of the demister. In a vane pack demister, the parallel sheets of corrugated metal are oriented with their lengths in a generally vertical position forming generally vertical channels through which a vertical vapor stream can flow in a vessel. As the vapor stream passes through the vertical channels of the vane pack demister, liquid droplets leave the vapor stream and attach to the vanes where they coalesce into a liquid that drains into drainage channels. The parallel sheets of corrugated metal forming the vane pack define a vane top plane with the top edges of the vanes, a vane bottom plane with the bottom edges of the vanes, a first longitudinal side, and a second longitudinal side.

Similar to the mesh demister, the vane top plane can be oriented to a non-horizontal position to facilitate drainage of the liquid into the drainage channel. In other words, the vane top plane can form an acute angle with a horizontal top plane defined by the perimeter of the vane pack demister. The non-horizontal orientation of the vane top plane may be formed by shaping each vane to have a non-rectangular shape, such as a parallelogram, that results in the top edges of the vanes defining a vane top plane that is non-horizontal when the vane pack demister is installed for use in a vessel. Alternatively, the non-horizontal vane top plane could be achieved by slightly tilting the vanes. In yet other embodiments, the non-horizontal vane top plane may be achieved by other methods.

It should be understood that the mesh demister illustrated in FIGS. 1-4 is an example and that in alternate embodiments the mesh demister can take alternate forms. For example, in alternate embodiments, aspects of the mesh demister can have different shapes, different dimensions, or different proportions. Additionally, in alternate embodiments, certain of the features of the mesh demister illustrated in FIGS. 1-4 may be modified or omitted. Furthermore, in alternate embodiments additional features may be added to the mesh demister. The components of the mesh demisters in accordance with the example embodiments herein can be made from a variety of materials, including but not limited to polymers, carbon fiber, metals, metal alloys, and composites.

For any figure shown and described herein, one or more of the components may be omitted, added, repeated, and/or substituted. Additionally, it should be understood that in certain cases components of the example embodiments can be combined or can be separated into subcomponents. Accordingly, embodiments shown in a particular figure should not be considered limited to the specific arrangements of components shown in such figure. Further, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure.

Terms such as “first”, “second”, “top”, “bottom”, “side”, “distal”, “proximal”, and “within” are used merely to distinguish one component (or part of a component or state of a component) from another. Such terms are not meant to denote a preference or a particular orientation, and are not meant to limit the embodiments described herein. In the example embodiments described herein, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The terms “a,” “an,” and “the” are intended to include plural alternatives, e.g., at least one. The terms “including”, “with”, and “having”, as used herein, are defined as comprising (i.e., open language), unless specified otherwise.

When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. Numerical end points of ranges disclosed herein are approximate, unless excluded by proviso.

Values, ranges, or features may be expressed herein as “about”, from “about” one particular value, and/or to “about” another particular value. When such values, or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means ±20% of the stated value, ±15% of the stated value, ±10% of the stated value, ±5% of the stated value, ±3% of the stated value, or ±1% of the stated value.

Although embodiments described herein are made with reference to example embodiments, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A mesh demister comprising:
a height and a perimeter, wherein the perimeter at a top of the mesh demister defines a horizontal top plane;
a first drainage channel extending across a portion of the mesh demister, the first drainage channel comprising a first flange support extending from a bottom surface of the first drainage channel;
a mesh pad disposed adjacent to the first drainage channel, the mesh pad comprising a top surface, a bottom surface, a first longitudinal side, and a second longitudinal side, wherein the first longitudinal side is supported by the first flange support, and wherein the top surface is non-horizontal when the mesh demister is in use;
a first lateral support and a second lateral support, the first and second lateral supports supporting the first drainage channel; and
a lower grid comprising a lower grid lateral segment and a lower grid longitudinal segment, the lower grid longitudinal segment extending from the first lateral support to the second lateral support, wherein the lower grid longitudinal segment supports a mesh peak of the mesh pad.

2. The mesh demister of claim 1, wherein the mesh top surface forms an acute angle with the horizontal top plane at the mesh peak, wherein the acute angle is 2 degrees to 20 degrees.

3. The mesh demister of claim 1, wherein the mesh top surface forms an acute angle with the horizontal top plane on opposing sides of the mesh peak.

4. The mesh demister of claim 1, wherein the mesh pad has a uniform thickness.

5. The mesh demister of claim 1, wherein the mesh peak is located along a longitudinal centerline of the mesh pad.

6. The mesh demister of claim 1, further comprising a second drainage channel extending across a portion of the mesh demister, the second drainage channel comprising a second flange support extending from a bottom surface of the second drainage channel, wherein the second longitudinal side of the mesh pad is supported by the second flange support.

7. The mesh demister of claim 6, wherein liquid droplets in the mesh pad coalesce and drain from the mesh peak toward the first longitudinal side and into the first drainage channel and toward the second longitudinal side and into the second drainage channel.

8. The mesh demister of claim 1, wherein the mesh pad has a rectangular prism shape.

9. The mesh demister of claim 1, wherein the mesh pad comprises a left pad segment and a right pad segment, and wherein the left pad segment and the right pad segment meet at the mesh peak.

10. The mesh demister of claim 6, wherein the first drainage channel has a first down pipe and wherein the second drainage channel has a second down pipe.

11. The mesh demister of claim 6, wherein the lower grid lateral segment is disposed:
between the first flange support and the first longitudinal side of the mesh, and
between the second flange support and the second longitudinal side of the mesh.

12. The mesh demister of claim 6, wherein the first lateral support and the second lateral support are fastened to the first drainage channel and the second drainage channel.

13. The mesh demister of claim 1, wherein the first lateral support and the second lateral support are configured to fasten to a support ring disposed on an interior surface of a vessel.

14. The mesh demister of claim 6, further comprising a peripheral mesh pad disposed between the second drainage channel and the perimeter of the mesh demister.

15. The mesh demister of claim 14, wherein the peripheral mesh pad comprises a peripheral mesh top surface, a peripheral mesh bottom surface, a first peripheral mesh longitudinal side, and a second peripheral mesh longitudinal side.

16. The mesh demister of claim 15, wherein the first peripheral mesh longitudinal side is supported by a third flange support extending from the bottom surface of the second drainage channel and the second peripheral mesh longitudinal side is supported by a second lower grid longitudinal segment of the lower grid.

17. The mesh demister of claim 15, wherein the peripheral mesh top surface comprises a peripheral mesh peak and wherein the peripheral mesh top surface is non-horizontal when the mesh demister is in use.

18. The mesh demister of claim 17, wherein liquid droplets in the peripheral mesh pad coalesce and drain from the peripheral mesh peak toward the first peripheral mesh longitudinal side and into the second drainage channel.

19. A vane pack demister comprising:
a height and a perimeter, wherein the perimeter at a top of the vane pack demister defines a horizontal top plane at a top of the height of the perimeter;
a first drainage channel extending across a portion of the demister, the first drainage channel comprising a first flange support extending from a bottom surface of the first drainage channel;
a vane pack disposed adjacent to the first drainage channel, the vane pack comprising parallel sheets of corrugated metal forming a vane top plane, a vane bottom plane, a first longitudinal side, and a second longitudinal side, wherein the first longitudinal side is supported by the first flange support, and wherein the vane top plane is non-horizontal when the demister is in use;
a first lateral support and a second lateral support, the first and second lateral supports supporting the first drainage channel; and
a lower grid comprising a lower grid lateral segment and a lower grid longitudinal segment, the lower grid longitudinal segment extending from the first lateral support to the second lateral support, wherein the lower grid longitudinal segment supports a vane pack peak of the vane pack.

20. The vane pack demister of claim 19, wherein the vane top plane forms an acute angle with the horizontal top plane at the vane pack peak, wherein the acute angle is 2 degrees to 20 degrees.
